(19) United States
(12) Patent Application Publication
(10) Pub. No.: US 2025/0155573 A1
(43) Pub. Date: May 15, 2025

(54) VEHICLE WITH A GATED CAMERA AND METHOD FOR OPERATING A VEHICLE UTILIZING A GATED CAMERA

(71) Applicant: Torc Robotics, Inc., Blacksburg, VA (US)

(72) Inventor: Fridtjof Stein, Ostfildern (DE)

(21) Appl. No.: 18/945,261

(22) Filed: Nov. 12, 2024

(30) Foreign Application Priority Data
Nov. 13, 2023 (DE) DE102023131471.8

(51) Int. Cl. G01S 17/18; G01S 7/481; G01S 7/484; G01S 17/931

(52) U.S. Cl. CPC G01S 17/18; G01S 7/4814; G01S 7/484; G01S 17/931

(57) ABSTRACT

The present disclosure relates to a method for operating a vehicle, wherein a dark section of a roadway in a longitudinal direction in front of the vehicle is illuminated by means of at least one gated camera arranged on the vehicle and at least one light source synchronized therewith and arranged on the vehicle, wherein the illumination is tracked according to an ego speed of the vehicle.

### CROSS-REFERENCE TO RELATED APPLICATIONS

The present application claims priority to German Patent Application No. 102023131471.8, filed on Nov. 13, 2023, and titled “VEHICLE AND METHOD FOR OPERATING A VEHICLE”, which is hereby incorporated by reference in its entirety.

### TECHNICAL FIELD

The present disclosure relates to a method for operating a vehicle utilizing a gated camera and a light source.

### BACKGROUND

In the future, automatically driving vehicles, such as trucks and passenger vehicles, will increasingly be underway on freeways and other roads.

Such vehicles locate themselves using sensors (typically lidar, camera, radar) and map data in the existing infrastructure and adjust their driving behavior to other road users measured by the sensors.

These sensors installed for this purpose have measurement characteristics that are determined by the sensor type, the design, and physical boundary conditions. Typically, the installed sensors have different tasks. For example, the lidar measures a traffic-relevant area in front of the vehicle in three dimensions. At the same time, the data from a camera are used to determine the semantics of the scenery viewed and to recognize traffic signs and traffic lights.

Requirements derived therefrom determine sensor parameters such as base width, focal length, aperture angle, pixel density, sensor type (color or monochrome), etc.

Roads have unshaded or weakly shaded areas as well as heavily shaded areas.

DE 10 2021 000 447 A1 describes a method for operating a gated camera having an illumination device and an optical sensor, wherein an actuation of the illumination device and the optical sensor are coordinated in time with one another, wherein a visible distance range is assigned to the coordinated actuation, wherein a detection area of the surroundings detection sensor system is detected by means of a surroundings detection sensor system, wherein a partial detection area is evaluated as part of the detection area which has a smaller distance to the optical sensor than a near boundary of the visible distance range, wherein objects in the partial detection area are searched for by means of the surroundings detection sensor system, wherein a found object is classified as recognized based on at least one classification criterion, wherein the gated camera is deactivated if a found object is classified as recognized.

### BRIEF DESCRIPTION

The present disclosure is based on the object of specifying a novel method for operating a vehicle and a novel vehicle.

A method for operating a vehicle is proposed in which, according to the present disclosure, a dark section of a roadway in a longitudinal direction in front of the vehicle is illuminated by means of at least one gated camera arranged on the vehicle and at least one light source synchronized therewith and arranged on the vehicle, wherein the illumination is tracked according to an ego speed of the vehicle.

The method can be used in particular during the day to illuminate shaded sections of the roadway.

In one embodiment, the gated camera and the light source are switched on when the beginning of a dark section is recognized in order to specifically illuminate the dark section.

In one embodiment, the beginning of the dark section is recognized by means of information from at least one sensor arranged on the vehicle and/or by information from an internal map.

In one embodiment, the gated camera and the light source are operated so that the dark section is illuminated from a starting position from the beginning of a shadow to an end position.

In one embodiment, the end position corresponds to a defined maximum range of the light source. Alternatively, the end position can correspond to a rear wall of an enclosed area forming the dark section.

In one embodiment, the dark section can be part of a tunnel, an underpass, a garage, a parking garage, an underground parking garage, or a passage through dense forest.

According to one aspect of the present disclosure, a vehicle is proposed comprising at least one gated camera oriented forward in a longitudinal direction and at least one light source synchronized therewith. According to the present disclosure, the vehicle is configured to carry out the above-described method.

In one embodiment, the gated camera is designed as a mono camera, wherein two light sources are arranged offset from the gated camera and from one another. Alternatively, the gated camera can be designed as a stereo camera having two cameras spaced apart from one another by a base width, wherein exactly one or at least one light source is arranged offset from the two cameras of the gated camera.

In one embodiment, the vehicle can be designed as a utility vehicle or bus.

In one embodiment, the vehicle can be designed as a semiautonomous or fully autonomous vehicle.

The solution according to the present disclosure enables targeted illumination of shaded dark areas along the travel path. Lane markings in dark areas can be better detected due to the illumination. This makes it possible to improve the lateral control quality. Darkly dressed people, cyclists, or objects that cannot be driven over in dark areas become better visible due to the solution according to the present disclosure. An improvement of the longitudinal control can thus be achieved.

In a vehicle having an advanced driver assistance system (ADAS), for example, the area detected by the gated camera can be displayed on a monitor. Better lighting enables the driver to recognize obstacles and potential hazards in dark areas earlier. It is thus possible to react in a timely manner and the level of safety on the road is increased. If the surroundings are better illuminated, the eyes of the driver have to strain less to recognize details. This results in reduced fatigue and increases the concentration of the driver on longer journeys.

Good lighting contributes to a more pleasant and comfortable driving experience since the driver can see better and feel safer.

### BRIEF DESCRIPTION OF DRAWINGS

Exemplary embodiments of the present disclosure will be explained in more detail hereinafter with reference to drawings.

In the figures:

FIG. 1 shows a schematic view of a vehicle on a roadway,

FIG. 2 shows a schematic view of the roadway partially extending through a tunnel, wherein the vehicle travels on the roadway,

FIG. 3 shows a schematic view of the roadway, the tunnel, and the vehicle at a later time,

FIG. 4 shows a schematic view of the roadway, the tunnel, and the vehicle at an even later time, and

FIG. 5 shows a schematic view of a processing chain in the vehicle.

Corresponding parts are provided with the same reference numerals in all figures.

### DETAILED DESCRIPTION

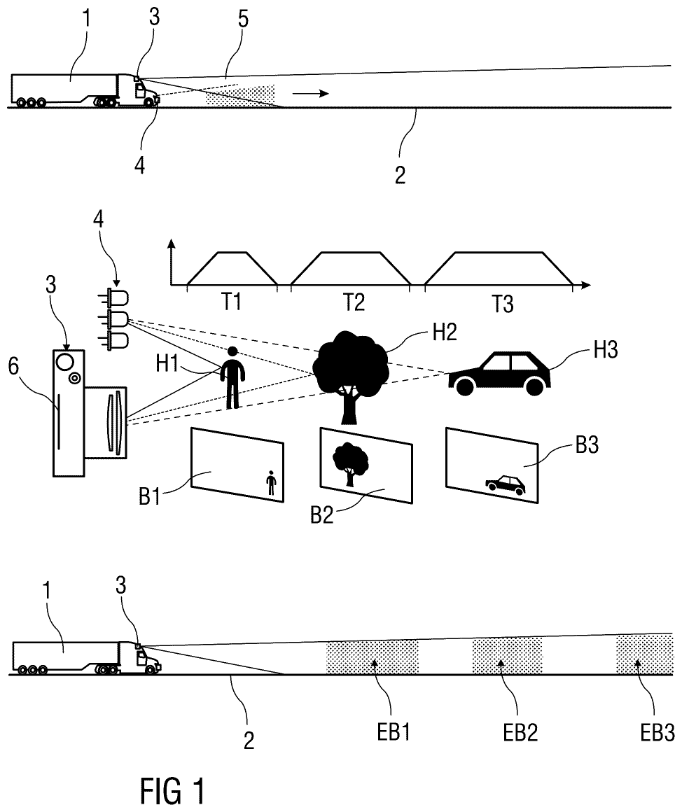

FIG. 1 is a schematic view of a vehicle 1, in particular a utility vehicle, on a roadway 2. The vehicle 1 can be designed as a semiautonomous or fully autonomous vehicle 1. The vehicle 1 has at least one gated camera 3, the viewing volume 5 (frustum) of which can be oriented in a longitudinal direction x, i.e. forward, and at least one light source 4, for example a laser light source, for pulsed illumination of the roadway 2. The light source 4 is arranged spatially offset to the gated camera 3, for example offset in a vertical direction and/or in a transverse direction.

The gated camera 3 combines the light time-of-flight of the emitted light with tight closing times of a pixel gate array of an image sensor 6 designed as a CMOS image sensor, which is time-synchronized with the light source 4, and in this way generates images B1, B2, B3, which are referred to as “gates”. “Gates” are images B1, B2, B3, which represent only the light that has travelled the distance between light source 4 and image sensor 6 within a specified time interval T1, T2, T3 (closing time of the image sensor 6), and thus certain distance ranges EB1, EB2, EB3. By setting a delay between illumination and image capture, the surroundings can be divided into individual images B1, B2, B3, which only depict a certain distance range EB1, EB2, EB3. The gated camera 3 has advantages in the case of atmospheric disturbances, since it implicitly suppresses reflections outside the gates (backscatter avoidance).

The gated camera 3, for example, uses its global shutter technology and illumination by VSCEL light pulses to record 90 images per second.

This high frequency enables new measurement approaches. The terms gate and slice are used synonymously here.

Gated cameras 3 can be used to recognize obstacles H1, H2, H3 on a roadway 2. This makes an important contribution to the safe operation of autonomous vehicles 1. For this purpose, the light sources 4 used are spatially separated from the image sensor 6 and offset, resulting in a shading of the area behind an obstacle H1, H2, H3 on the roadway 2, which appears significantly larger in the image B1, B2, B3 than the actual object or obstacle H1, H2, H3 is shown in the image B1, B2, B3. This effect and the shadow shape due to multiple light sources 4 significantly facilitate the recognition of obstacles H1, H2, H3 in the image B1, B2, B3.

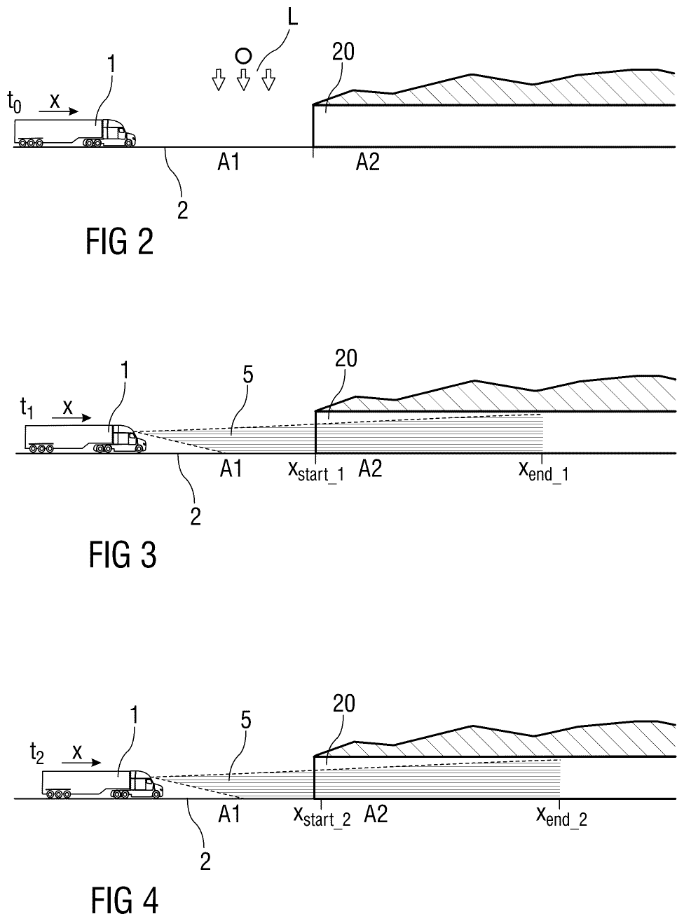

FIG. 2 shows a schematic view of the roadway 2 partially extending through a tunnel 20, wherein the vehicle 1 travels on the roadway 2. The vehicle 1 can, for example, be designed as a utility vehicle, bus, or passenger vehicle. Furthermore, the vehicle 1 can be designed as an autonomous or semiautonomous vehicle.

At a time t₀, the vehicle 1 is traveling in a section A1 of the roadway 2 outside the tunnel 20 in daylight, for example sunlight L. The section A1 is therefore well illuminated. A further section A2 of the roadway 2 follows the section A1 in the longitudinal direction x in front of the vehicle 1, is located in the tunnel 20, and is therefore correspondingly poorly illuminated.

FIG. 3 is a schematic view of the roadway 2, the tunnel 20, and the vehicle 1 at a time t₁.

The gated camera 3 and the light source 4 are switched on to specifically illuminate the poorly illuminated section A2 through one or more gates. This can be triggered, for example, by detection of the tunnel entrance or by information from an internal map. The gated camera 3 and the light source 4 are operated in such a way that the section A2 is illuminated from a starting position x_{start_1} from the beginning of the shading, i.e. the tunnel entrance, to an end position x_{end_1}, which can correspond to a defined maximum range xₘₐₓ of the light source 4, at which the light of the light source 4 can still be used meaningfully by the gated camera 3.

FIG. 4 is a schematic view of the roadway 2, the tunnel 20, and the vehicle 1 at a time t₂. The vehicle 1 has continued to move towards the tunnel and thus towards the section A2. The starting position x_{start_1} and the end position x_{end_1} were tracked taking into consideration an ego speed V_{ego} of the vehicle 1. The following applies to the new starting position x_{start_2}:

$${x}_{start \_ 2} = {x}_{start \_ 1} + ( {t}_{2} - {t}_{1} ) {V}_{ego}$$

The new end position x_{end_2} again corresponds to the maximum range xₘₐₓ of the light source 4.

If the poorly illuminated section A2 is not an area open in the longitudinal direction x, such as a tunnel 20 or an underpass, but an enclosed area, such as a garage, then the end position t_{end_1} at time t₁ can correspond at most to a rear wall of the enclosed area. Accordingly, the new end position x_{end_2} is determined as follows:

$${x}_{end \_ 2} = {x}_{end \_ 1} + ( {t}_{2} - {t}_{1} ) \cdot {V}_{ego}$$

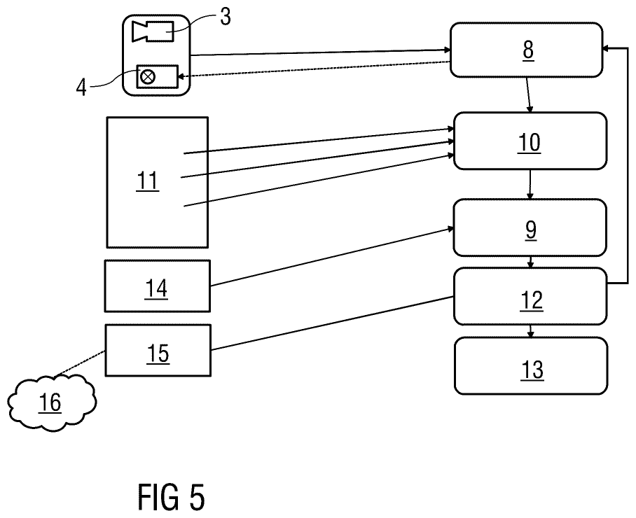

FIG. 5 is a schematic view of a processing chain in the vehicle 1.

A control unit 8 for the gated camera 3 and its light source 4 is provided, which can be configured to detect objects in images B1, B2, B3 of the gated camera 3. The detected objects are fed to a fusion module 10, which performs a sensor fusion with data from other sensors 11. At least one lidar sensor, at least one radar sensor, and/or at least one camera can be provided as further sensors 11.

The fused data are compared with data from a digital map 9, possibly taking into consideration data from a satellite navigation system 14 (for example GPS), and fed to a behavior planning module 12, which determines a trajectory for the vehicle 1, which is implemented by means of an actuator system 13 with regard to longitudinal control and lateral control.

Furthermore, a communication module 15 can be provided for wireless communication of the behavior planning module 12 with a backend 16.

The gated camera 3 can, for example, be designed as a mono camera, wherein two light sources 4 can be arranged offset from the gated camera 3 and from one another. For example, the gated camera 3 can be arranged in the area above a windshield of the vehicle 1. The two light sources 4 can, for example, be arranged on the left and right in the area of a bumper of the vehicle 1.

In another embodiment, the gated camera 3 can be designed, for example, as a stereo camera having two cameras spaced apart from one another by a base width. The cameras can, for example, be arranged on the left and right in the area above a windshield of the vehicle 1. In this case, for example, a single light source 4 can be arranged offset from the two cameras of the gated camera 3, for example centrally in the area above the windshield of the vehicle 1.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for operating a vehicle, the method comprising:
identifying a dark section of a roadway in a longitudinal direction in front of the vehicle;
illuminating the dark section of roadway by using at least one gated camera arranged on the vehicle and at least one light source synchronized therewith and arranged on the vehicle; and
tracking the illumination according to an ego speed of the vehicle.

2. The method according to claim 1, further comprising switching on the gated camera and the light source when a beginning of the dark section is recognized in order to specifically illuminate the dark section.

3. The method according to claim 2, wherein the beginning of the dark section is recognized by using information from at least one sensor and/or by using information from an internal map.

4. The method according to claim 1, wherein the gated camera and the light source are operated such that the dark section is illuminated from a starting position from the beginning of a shadow to an end position.

5. The method according to claim 4, wherein the end position corresponds to a defined maximum range of the light source, or that the end position corresponds to a rear wall of an enclosed area forming the dark section.

6. The method according to claim 1, wherein the dark section is part of a tunnel, an underpass, a garage, a parking garage, or an underground parking garage.

7. A vehicle comprising at least one gated camera oriented forward in a longitudinal direction and at least one light source synchronized therewith, wherein the vehicle is configured to
identify a dark section of a roadway in the longitudinal direction in front of the vehicle;
illuminate the dark section of the roadway by using the least one gated camera arranged on the vehicle and the least one light source arranged on the vehicle; and
track the illumination of the dark section of the roadway according to an ego speed of the vehicle.

8. The vehicle according to claim 7,
wherein the gated camera is designed as a mono camera,
wherein two light sources are arranged offset from the gated camera and from one another, or that the gated camera is designed as a stereo camera which has two cameras which are spaced apart from one another by a base width, and
wherein exactly one or at least one light source is arranged offset from the two cameras of the gated camera.

9. The vehicle according to claim 7, wherein the vehicle is designed as a utility vehicle or bus.

10. The vehicle according to claim 7, wherein the vehicle is designed as a semiautonomous or fully autonomous vehicle.
